(19) United States
(12) Patent Application Publication
(10) Pub. No.: US 2011/0094386 A1
(43) Pub. Date: Apr. 28, 2011

(54) Marine Water Separating Fuel Filter

(76) Inventor: I-Sin PENG, Taichung City (TW)

(21) Appl. No.: 12/200,540

(22) Filed: Aug. 28, 2008

(51) Int. Cl. B01D 46/42; F01N 3/021

(52) U.S. Cl. 96/414

(57) ABSTRACT

A marine water separating fuel filter includes a connecting tube head, an upper lid, a filter element, and a container. The filter element is accommodated in the container and sealed by the upper lid. The upper lid has a gear ring to engage with an alveolus ring provided on an axial trough of the filter element. An axial rod of the connecting tube head is screwed to the axial trough. The connecting tube head has a pressing ring to hold against a washer, providing a sealing function. The gas from an inlet end is filtered with the filter element and then expelled through an outlet end. Oily water flows to the central bottom of the container due to a curved section at a lower end of the container. An indication ring is provided on the hollow taper post to indicate the height of liquid. This is an easy and quick way to assemble and disassemble the filter element, providing environmental and economical purposes.

### BACKGROUND OF THE INVENTION

1. Field of the Invention

The present invention relates to a marine water separating fuel filter, and more particularly to one having a filter element accommodated in a container and sealed with an upper lid. The upper lid has a gear ring to engage with an alveolus ring provided on an axial trough of the filter element. An axial rod of the connecting tube head is screwed to the axial trough. An axial rod of a connecting tube head is screwed to the axial trough of the filter element. The connecting tube head has a pressing ring to hold against a washer, providing a sealing function. Unfiltered gas from an inlet end is filtered with the filter element and filtered gas is expelled through an outlet end. It is easy and quick to assemble and disassemble the filter element.

2. Description of the Prior Art

There are two types of filter 6 on the market, one is unable to drain oily water and the other is able to drain oily water. The former includes a metallic container 61 to accommodate a filter element 62. The filter element 62 has an axial threaded trough 621 and an upper surface 622, as shown in FIG. 5. A rubber washer 611 is placed on the metallic container 61 to provide a sealing function for an inner air room when the connecting tube head is screwed to the filter element 62, as shown in FIG. 4-A. The latter is substantially similar to the former with the exceptions described hereinafter. The metallic container 61 is provided with a base 63 to store liquid. A drain valve 631 is screwed to the bottom of the base 63. The conventional filters have the following shortcomings:

(1) The former doesn't provide a device to drain oily water. It is necessary to replace a new one after a period of time.

(2) The latter is provided with the base and the drain valve is disposed at one end of the bottom of the container, but the bottom of the container is a flat which is unable to drain the oily water completely.

(3) The metallic container is integrally formed with the filter element. It is required to replace the filter element along with the metallic container. This design is not cost-effective.

### SUMMARY OF THE INVENTION

According to the present invention, there is provided a marine water separating fuel filter, comprising:

a connecting tube head having a number of outlets at respective sides thereof, one set of the outlets interconnecting with an axial rod, the other outlets interconnecting with an air room surrounded with a pressing ring;

an upper lid in a bottle cap shape having a threaded section around an inner wall thereof, a number of notches around an outer wall thereof, and a top, the top being formed with a groove, a number of air holes, and a gear ring having inner teeth in sequence toward inward, the upper lid further comprising a washer having a lower end to hold against the groove;

a filter element having a hollow filtering body with an axial trough protruding from an upper end of the filter element, the axial trough having an inner threaded section, an alveolus ring being provided on the circumference of the axial trough; and

a container having an opening facing upward and a number of ribs around an outer wall thereof, a threaded section and a circular engaging board being provided at an upper section of the container and a circular ring being provided on the engaging board, a hollow taper post extending upward from a central bottom of the container, the hollow taper post having a plurality of slots, an outlet protruding outward from the bottom of the container, the outlet having an inner threaded section for connection of a drain valve, an indication ring being provided on the hollow taper post, the container having a curved section a lower end thereof;

thereby, the filter element being accommodated in the container and sealed by the upper lid with the circular ring, the gear ring engaging with the alveolus ring, the axial rod of the connecting tube head being screwed to the axial trough of the filter element, the pressing ring holding against the washer to provide a sealing function, gas from an inlet end being filtered with the filter element and expelled through an outlet end, filtered oily water flowing to the central bottom of the container by means of the curved section of the container, the indication ring indicating the height of liquid.

It is the primary object of the present invention to provide a marine water separating fuel filter, which is easy and convenient to replace a filter element.

It is another object of the present invention to provide a marine water separating fuel filter, which is cost-effective.

It is a further object of the present invention to provide a marine water separating fuel filter, which provides an indication ring to clearly indicate the height of liquid.

It is still a further object of the present invention to provide a marine water separating fuel filter, which provides a hollow taper post having a plurality of slots and a container having a curved section at a lower end thereof for draining oily water easily.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 3-A is a partially enlarged view of FIG. 3;

FIG. 3-B is a sectional view of a container of the present invention;

FIG. 4 is an exploded view according to a preferred embodiment of the present invention;

FIG. 4-A is another perspective view of a connecting tube head of the present invention;

FIG. 5 is an exploded view of a conventional filter; and

FIG. 6 is an exploded view of another conventional filter.

### DETAILED DESCRIPTION OF THE INVENTION

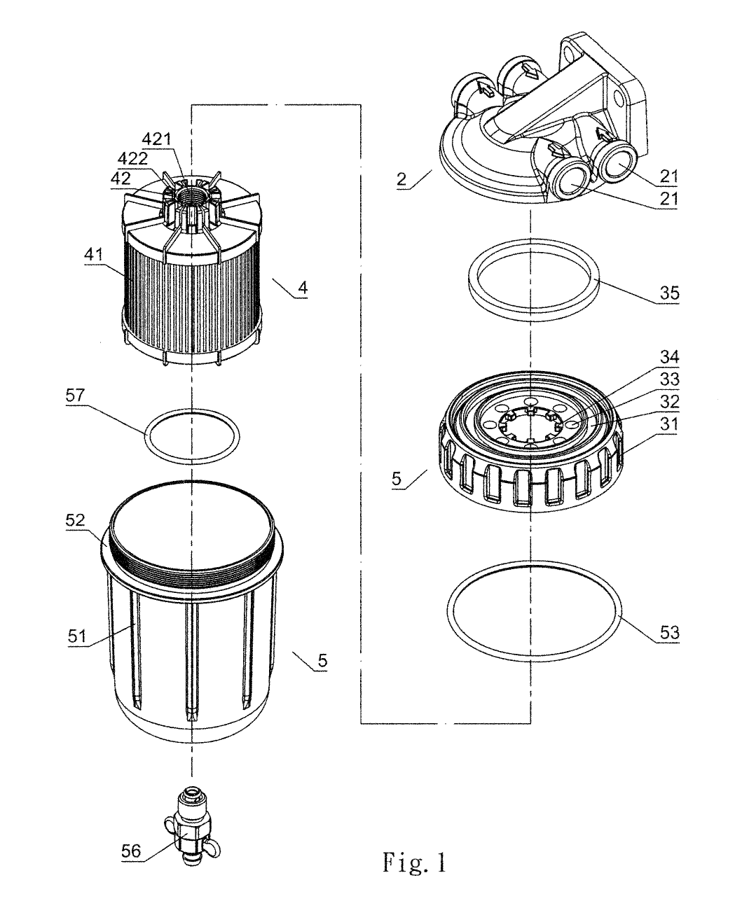

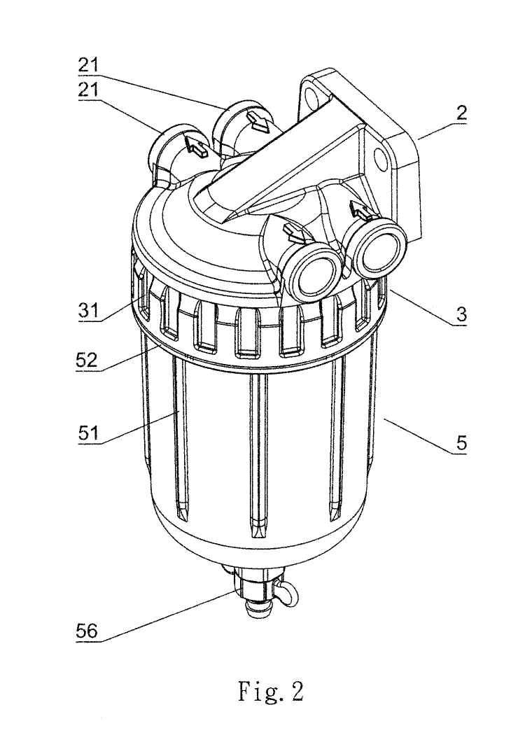

As shown in FIGS. 1, 2, 3-A and 4-A, the present invention comprises a connecting tube head 2, an upper lid 3, a filter element 4, and a container 5.

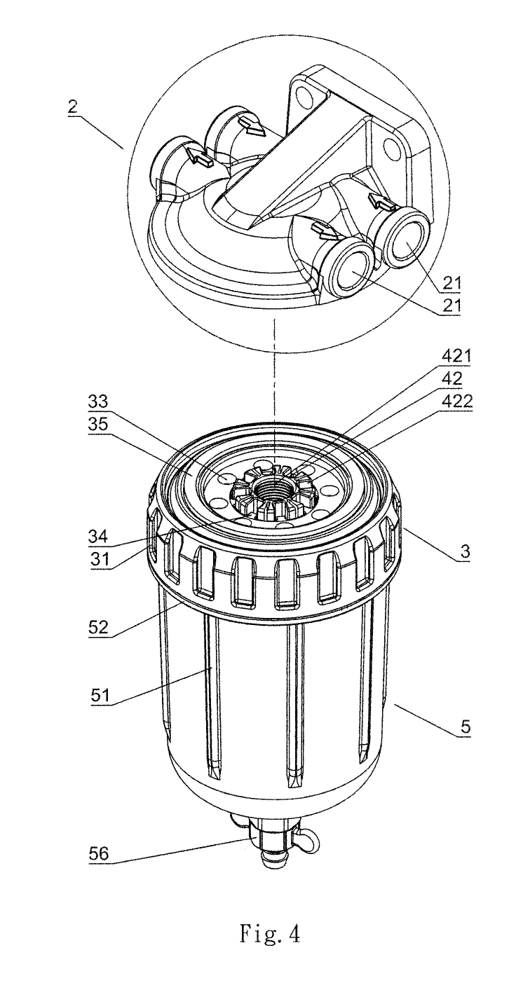

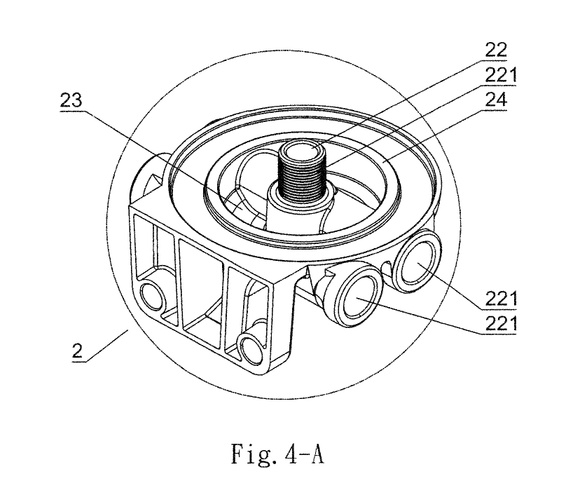

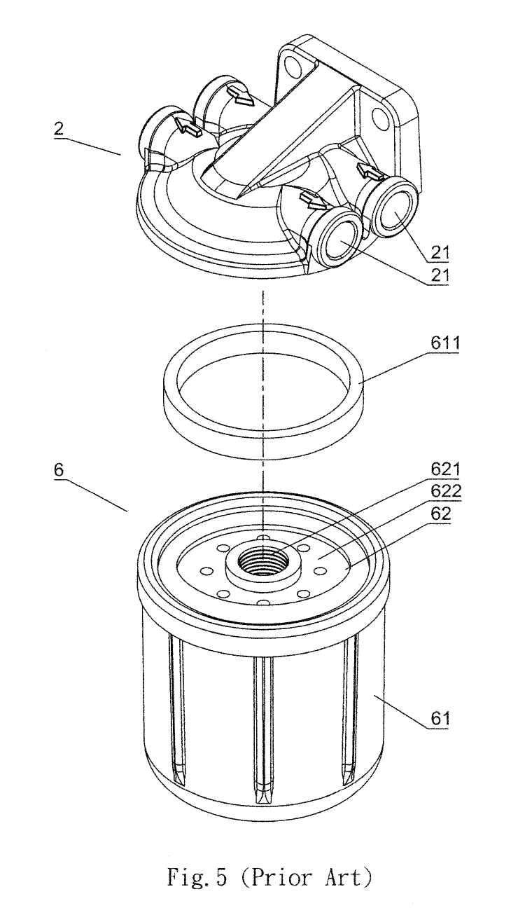

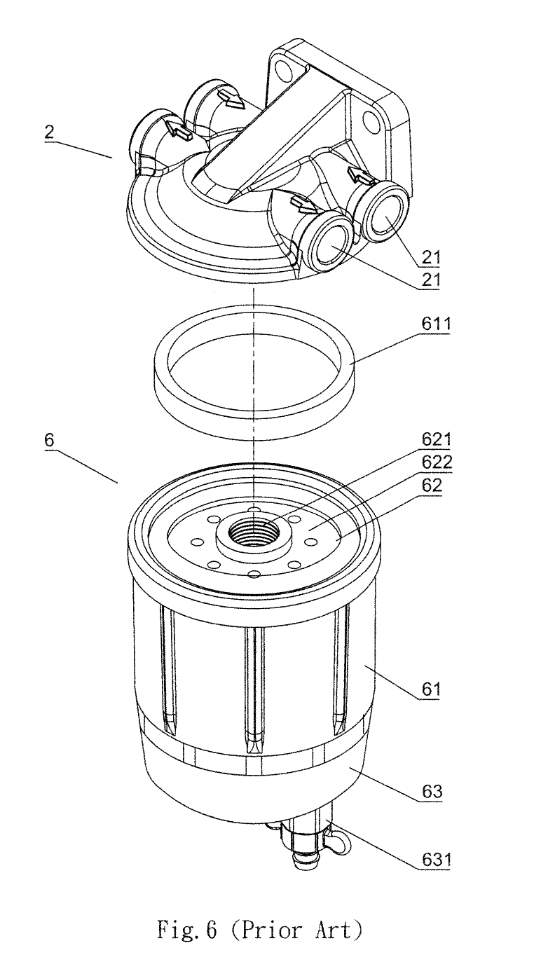

The connecting tube head 2 has a number of outlets 21 at respective sides thereof. One set of the outlets 21 interconnects with an axial rod 22 for unfiltered gas entering the filter element 4. The axial rod 22 has an outer threaded section 221 at a lower end thereof. The other outlets 21 interconnect with an air room 23, as shown in FIG. 4-A. The connecting tube head 2 has a pressing ring 24 around the air room 23 to engage with an upper end of a washer 35.

The upper lid 3 is in a bottle cap shape. The upper lid 3 has a threaded section around an inner wall thereof and a number of notches 31 or ribs around an outer wall for enhancing rotation of the upper lid 3. The top of the upper lid 3 is formed with a groove 32, a number of air holes 33, a gear ring 34 in sequence toward inward. The groove 32 is adapted to accommodate the washer 35. The air holes 33 are adapted to expel filtered gas. The gear ring 34 has inner teeth to engage with an alveolus ring 422 of the filter element 4

The filter element 4 has a hollow filtering body 41. The filter element 4 is formed with an axial trough 42 protruding from the top of the filter element 4. The axial trough 42 has an inner threaded section 421. The alveolus ring 422 is provided on the circumference of the axial trough 42 for engaging with the gear ring 34 of the upper lid 3.

The container 5 is a hollow cylinder. The container 5 has an open facing upward and a number of notches or ribs 51 around an outer wall thereof for enhancing rotation of the container 5. A threaded section and a circular engaging board 52 are provided at an upper section of the container 5 and a circular ring 53 is provided on the engaging board 52 to engage with the upper lid 3. The container 5 has a curved section at a lower end thereof for collecting oily water W. A hollow taper post 54 extends upward from the central bottom of the container 5. An outlet 55 protrudes outward from the bottom of the container 5. The hollow taper post 54 is formed with a plurality of slots 541 for coupling with the central bottom of the filter element 4 and draining oily water. The outlet 55 has an inner threaded section for connection of a drain valve 56 to control drainage and storage of the oily water W. An indication ring 57 is provided on the hollow taper post 54 to indicate the height of the oily water W. The indication ring 57 may be a plastic ring or a rubber ring.

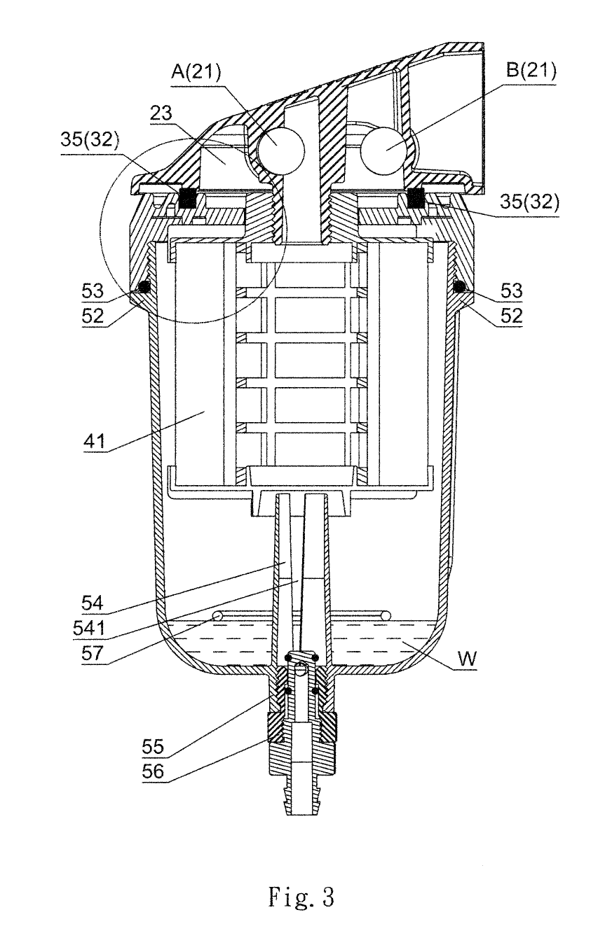

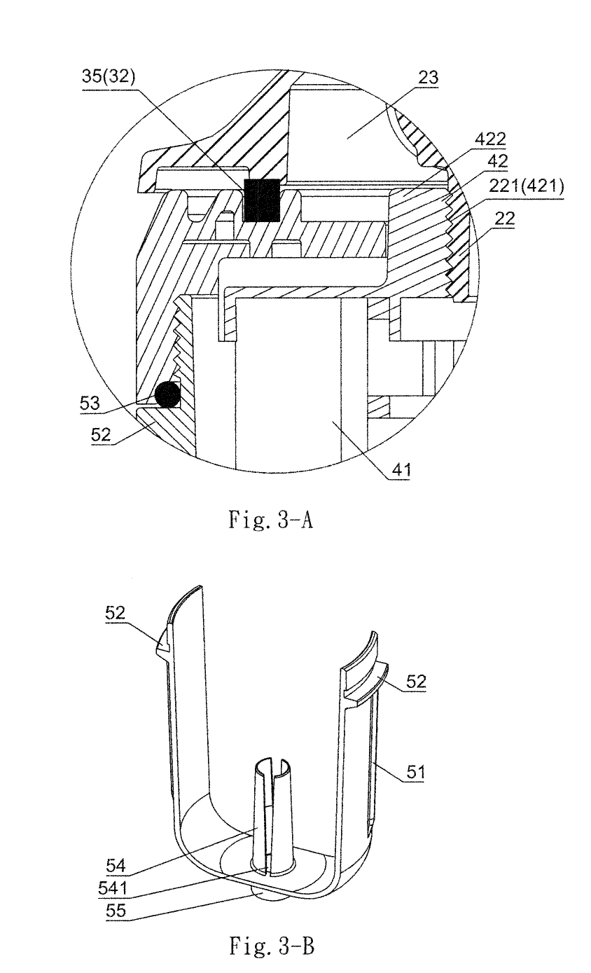

As shown in FIGS. 1, 3, 3-A and 4, the central bottom of the filter element 4 is placed on the hollow taper post 54 of the container 5. The gear ring 34 of the upper lid 3 engages with the alveolus ring 422. The upper lid 3 is screwed to the threaded section at the upper section of the container 5, with the lower edge of the upper lid 3 engaging with the circular ring 53 to hold against the engaging board 52. The upper lid 3, the filter element 4 and the container 5 are sealed and assembled together to form a unit to be connected with the connecting tube head 2, as shown in FIG. 4. The axial rod 22 is screwed to the axial trough 42. The washer 35 holds against the pressing ring 24, as shown in FIG. 3-A, providing a sealing function. When the replacement of the filter element 4 is required, it is easy to rotate in an opposite direction to disassemble the upper lid 3 and the connecting tube head 2.

As shown in FIGS. 1 and 3, the outlet 21 interconnecting with the axial rod 22 is defined as an inlet end A for the unfiltered gas. Because the axial rod 22 is screwed to the axial trough 42, the unfiltered gas direct enters the filter element 4 and reaches the bottom of the container 5. Furthermore, the container 5 and the upper lid 3 are sealed. The gas is filtered through the filtering body 41 to produce the oily water W to be stored in the container 5, and the filtered gas flows through the air holes 33 into the air room 23. The pressing ring 24 holds against the washer 35, providing a sealing function. The outlets 21 interconnecting with the air room 23 is defined as an outlet end B for filtered gas. After a period of time, the filter element 4 is replaced simply to reuse the present invention. This design provides environmental and economical purposes.

As shown in FIGS. 1 and 3, when the oily water W rises, the indication ring 57 fitting onto the hollow taper post 54 will indicate the liquid level, preventing misjudgement due to the reflection or refraction of light. When the oily water W is drained, the oily water will flow toward the hollow taper post 54 due to the curved section of the container 5 and will be drained out from the slots 541 to the drain valve 56. This is a convenient way to monitor and drain the oily water W.

According to the aforesaid, the present invention provides a screwed way to assemble the connecting tube head 2, the upper lid 3, the filter element 4 and the container 5, with the washer 35 and the circular ring 53 to provide a tightly seal.

Although the present invention has been shown and described with respect to the preferred embodiment, it will be understood by those skilled in the art that various changes and modifications may be made without departing from the spirit and scope of the invention as defined in the following claims.

What is claimed is:

1. A marine water separating fuel filter, comprising:
a connecting tube head having a number of outlets at respective sides thereof, one set of the outlets interconnecting with an axial rod, the other outlets interconnecting with an air room surrounded with a pressing ring;
an upper lid in a bottle cap shape having a threaded section around an inner wall thereof, a number of notches around an outer wall thereof, and a top, the top being formed with a groove, a number of air holes, and a gear ring having inner teeth in sequence toward inward, the upper lid further comprising a washer having a lower end to hold against the groove;
a filter element having a hollow filtering body with an axial trough protruding from an upper end of the filter element, the axial trough having an inner threaded section, an alveolus ring being provided on the circumference of the axial trough; and
a container having an opening facing upward and a number of ribs around an outer wall thereof, a threaded section and a circular engaging board being provided at an upper section of the container and a circular ring being provided on the engaging board, a hollow taper post extending upward from a central bottom of the container, the hollow taper post having a plurality of slots, an outlet protruding outward from the bottom of the container, the outlet having an inner threaded section for connection of a drain valve, an indication ring being provided on the hollow taper post, the container having a curved section a lower end thereof;
thereby, the filter element being accommodated in the container and sealed by the upper lid with the circular ring, the gear ring engaging with the alveolus ring, the axial rod of the connecting tube head being screwed to the axial trough of the filter element, the pressing ring holding against the washer to provide a sealing function, gas from an inlet end being filtered with the filter element and expelled through an outlet end, filtered oily water flowing to the central bottom of the container by means of the curved section of the container, the indication ring indicating the height of liquid.

2. The marine water separating fuel filter as claimed in claim 1, wherein the notches of the upper lid is replaced with ribs.

3. The marine water separating fuel filter as claimed in claim 1, wherein the ribs of the container is replaced with notches.

4. The marine water separating fuel filter as claimed in claim 1, wherein the indication ring is either of a plastic ring and a rubber ring.
